(19) United States
(12) Patent Application Publication
(10) Pub. No.: US 2023/0297945 A1
(43) Pub. Date: Sep. 21, 2023

(54) CAPTURE OF EMMC CARD IDENTIFICATION FOR COMPONENT TRACEABILITY OF PCIE DAUGHTER CARD

(71) Applicant: Dell Products L.P., Round Rock, TX (US)

(72) Inventors: Hooi Yong Chng, Singapore (SG); Thomas G. Noonan, Round Rock, TX (US)

(21) Appl. No.: 17/695,913

(22) Filed: Mar. 16, 2022

(51) Int. Cl. G06Q 10/08; G06F 21/73; G06F 13/40

(52) U.S. Cl. CPC G06Q 10/087; G06F 21/73; G06F 13/4027; G06F 13/4063

(57) ABSTRACT

An inventory management system includes a first device having a first inventory identifier that uniquely identifies the first device. The first device includes a second device that has a second inventory identifier stored in a non-volatile memory of the second device. The second inventory identifier uniquely identifies the second device. A processing device is configured to execute code that reads the second inventory identifier from the non-volatile memory of the second device. An inventory log receives the second inventory identifier from the processing device, and associates the first device with the second inventory identifier.

### FIELD OF THE DISCLOSURE

This disclosure generally relates to information handling systems and more particularly relates to capturing of eMMC Card Identification for component traceability of PCIe daughter cards.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An inventory management system may include a first device having a first inventory identifier that uniquely identifies the first device. The first device may include a second device that has a second inventory identifier stored in a non-volatile memory of the second device. The second inventory identifier may uniquely identify the second device. A processing device may execute code that may read the second inventory identifier from the non-volatile memory of the second device. An inventory log may receive the second inventory identifier from the processing device, and may associate the first device with the second inventory identifier.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a piece-part source tracking system according to an embodiment of the current disclosure;

FIG. 2 is a flowchart illustrating a method for capturing and storing component identification information for component traceability according to an embodiment of the current disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

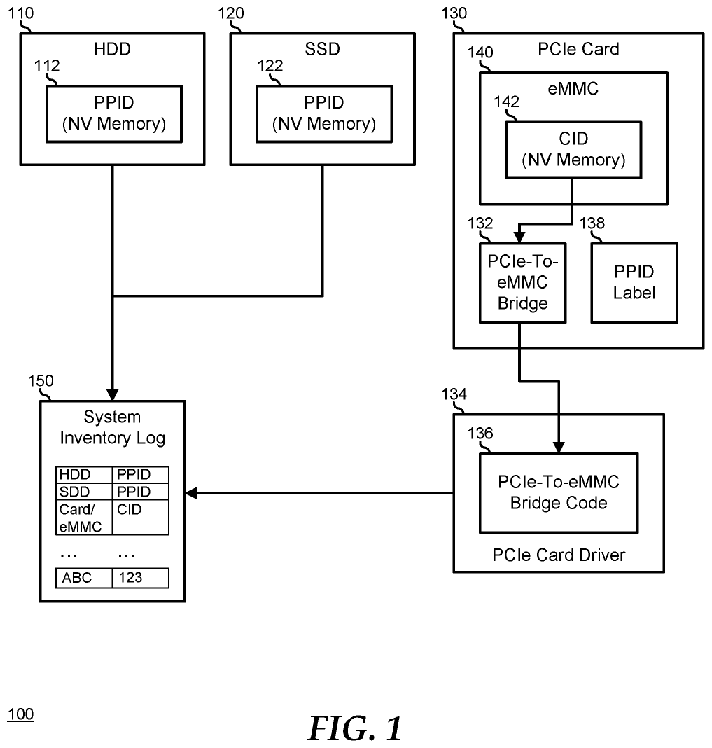

FIG. 1 illustrates a piece-part source tracking system 100. Tracking system 100 provides a data tracking system for tracking the sources and identities of individual piece parts in a manufacturer's product, such as an information handling system. tracking system 100 provides the manufacturer to maintain a database of selected piece parts within their products at the individual component level, rather than at the part-type level. Thus, where a particular product includes two or more of a particular tracked component, tracking system 100 provides tracking information for each instantiation of that particular component within an individual version of that product. A system inventory log 150 provides a database of tracked components within an individual system of a particular type. The manufacturer may maintain a similar system inventory log for each individual system of that particular type.

A manufacturer may maintain a larger scale tracking system that incorporates system inventory logs for each particular system of a given type, and for other types of systems as needed or desired. Tracking system 100, and any such larger scale tracking system may be maintained by the manufacturer in order to track sourcing information for the tracked piece parts, to track quality and reliability issues and warranty tracking for the piece parts, to demonstrate and ensure compliance with relevant governmental or customer tracking requirements, such as any “Buy American” or other requirements, or for other tracking purposes, as needed or desired. System inventory log 150 provides a database of tracked components for a hypothetical information handling system including at least one hard disk drive (HDD) 110, at least one solid state drive (SSD) 120, and at least one Peripheral Component Interconnect-Express (PCIe) card 130.

Manufacturers of piece parts such as HDD 110 and SSD 120 may typically provide unique identification information with each piece part. In a particular example, a part serial number, along with other information, such as a manufacturing date code, a manufacturing lot number, a manufacturer's manufacturing site identifier, and the like, may be combined to form a unique piece part identifier. For example, a particular piece part may include a Piece Part Identification (PPID) that includes a code for the piece part's country of origin, a part number ascribed by the manufacturer of the system into which the piece part is to be added (as opposed to a part number utilized by the manufacturer of the piece part), a manufacturer identifier, a date code for the date of manufacture of the piece part, and an alphanumeric sequence number ascribed to that piece part by the manufacturer of the piece part.

In a particular embodiment, the manufacturer of a particular piece part affixes a label to each piece part that includes the PPID for that particular piece part. Here, PCIe card 130 is illustrated as including a PPID label 138. While labels including a PPID may be sufficient for many uses, labels are subject to tampering. For example, genuine labels can be removed from piece parts, and counterfeit labels can affixed to the piece parts in place of the genuine labels. In this way, country of origin regulations can be easily subverted.

In another embodiment, the manufacturer of a particular piece part programs a non-volatile memory element of the piece part with the PPID information, or otherwise stores the PPID electronically and permanently on the piece part. Here, HDD 110 is illustrated as including a PPID 112 in a non-volatile memory element of the HDD, and SDD 120 is illustrated as including a PPID 122 in a non-volatile memory element of the SDD. The storage of PPID information on a non-volatile memory element of a particular piece part provides a more secure method for assuring the source of the particular piece part. Thus, when HDD 110 is received, PPID 112 is read from the HDD and stored in system inventory log 150. Similarly, when SDD 120 is received, PPID 122 is read from the SDD and stored in system inventory log 150. In addition, a manufacturer, upon receipt of a particular piece part, can read the PPID information from the particular part, and compare the information from the non-volatile memory of the piece part with the information from the PPID label to determine if any tampering has occurred with the piece part.

PCIe card 130 includes an Embedded MultiMedia Card (eMMC) 140. In a particular embodiment, eMMC 140 does not include a PPID, but the manufacturer of the eMMC provides a Card Identification (CID) 142 that is stored in a non-volatile memory device or designated portion of the eMMC memory. CID 142 includes fields for the manufacturer identification, device package type, firmware type, product name, product revision, product serial number, product manufacturing date, and checksum. Note that PPID label 138 provides a PPID associated with PCIe card 130, but the PPID information contained in the PPID label is not ascribed to eMMC 140, or in any way relate to the eMMC or CID 142. Thus, within the context of PPIDs, tracking system 100 has no native way to track a PPID for eMMC 140.

Moreover, as described above, PPID label 138 is vulnerable to tampering, and so the source of eMMC 140 is not natively assured by the tracking system, as are the sources for HDD 110 and SDD 120 (based upon the non-volatilely stored PPIDs 112 and 122). To rectify the vulnerability of eMMC 140 to tampering, or other mis-labeling of the source of the eMMC, tracking system 100 operates to ascribe CID 142, which is not vulnerable to tampering, to PCIe card 130, as described below. Moreover, even in the event no tampering occurs, the replacement of eMMC 140 with another eMMC on PCIe card 130 will not be reflected by PPID label 138, and any traceability of the eMMC would be lost.

Here, PCIe card 130 includes a PICe-to-eMMC bridge device 132 that operates to bridge communications from a PCIe interface, typically at a card edge of the PCIe card, to eMMC 140. As such, PCIe card 130 may be installed into a PCIe socket on an information handling system, and provide the functionality of eMMC 140 for the information handling system within a PCIe stack. As such, tracking system 100 includes a PCIe card driver 134 that provides an operating environment for PCIe card 130 within the broader operating environment of the information handling system. Thus PCIe card driver 134 may be instantiated in a BIOS/UEFI of the information handling system, in an operating system (OS) of the information handling system, within a management environment of the information handling system, such as an out-of-band operating environment provided by a baseboard management controller or the like, or in any other operating environment of tracking system 100 or the information handling system upon which the tracking system is instantiated, as needed or desired. Moreover, in the context of tracking system 100, the functions and features of PCIe card driver 134, as described herein, may be performed by other types of code than drivers, such as by an application running in a hosted environment of the information handling system, a firmware element instantiated in a BIOS/UEFI of the information handling system, a utility or service operating with the hosted environment or the management environment of the information handling system, or the like.

PCIe card driver 134 includes PCIe-to-eMMC bridge code 136 that operates to interface to eMMC 140 to read CID 142 from the eMMC. PCIe-to-eMMC bridge code 136 may represent proprietary code provided by the manufacturer of eMMC 140 in order to permit the reading of CID 142, or PCIe-to-eMMC bridge device 132 may be configured to implement a standard Non-Volatile Memory-Express (NVME) Identify command to read the CID, as needed or desired. Tracking system 100 operates to incorporate some or all of CID 142 into system inventory log 150, ascribing the CID information as the unique identification for PCIe card 130. In a particular embodiment, the serial number and manufacture data information from CID 142 is utilized to uniquely identify PCIe card 130. In this way, the combination of PCIe card 130 and eMMC 140 are coupled together for traceability purposes as a single uniquely identifiable component. Further, if eMMC 140 is replaced with anther eMMC, the CID information from the newly installed eMMC will be different, and will be used to uniquely identify the newly formed combination of PCIe card 130 and the newly installed eMMC.

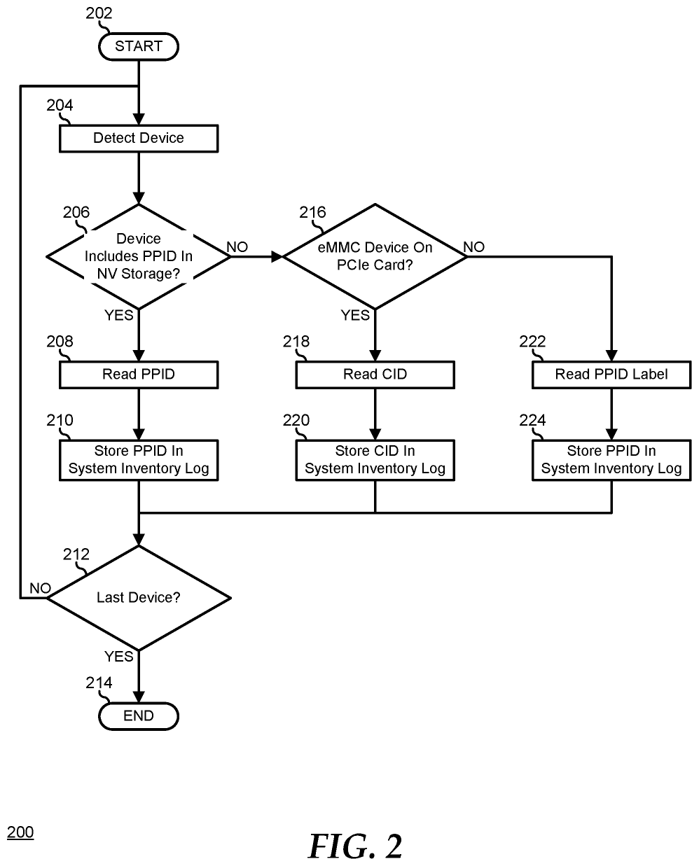

FIG. 2 illustrates a method 200 for capturing and storing component identification information for component traceability, starting at block 202. A particular device, for example, a device of an information handling system, is detected in block 204. A decision is made as to whether or not the device includes PPID information stored in a non-volatile storage of the device in decision block 206. If not, the “NO” branch of decision block 206 is taken as described below. If the device includes PPID information stored in a non-volatile storage of the device, the “YES” branch of decision block 206 is taken, the PPID is read from the non-volatile storage in block 208, and the PPID is stored to a SIL in block 210. A decision is made as to whether or not the device is the last device to be inventoried in decision block 212. If not, the “NO” branch of decision block 212 is taken, and the method returns to block 204 where the next device is detected. If the device is the last device to be inventoried, the “YES” branch of decision block 212 is taken and the method ends in block 214.

Returning to decision block 206, if the device does not include PPID information stored in a non-volatile storage of the device, the “NO” branch of the decision block is taken, and a decision is made as to whether or not the device represents a eMMC on a PCIe card in decision block 216. If not, the “NO” branch of decision block 216 is taken as described below. If the device represents a eMMC on a PCIe card, the “YES” branch of decision block 216 is taken, CID information is read from the non-volatile storage of the eMMC in block 218, the CID is stored to the SIL in block 220, and the method proceeds to decision block 212. Here, the CID information is ascribed to the combination of the PCIe card and the eMMC. Returning to decision block 216, if the device does not represent a eMMC on a PCIe card, the “NO” branch of the decision block is taken, the PPID is read from a PPID label in block 222, the PPID is stored to the SIL in block 224, and the method proceeds to decision block 212.

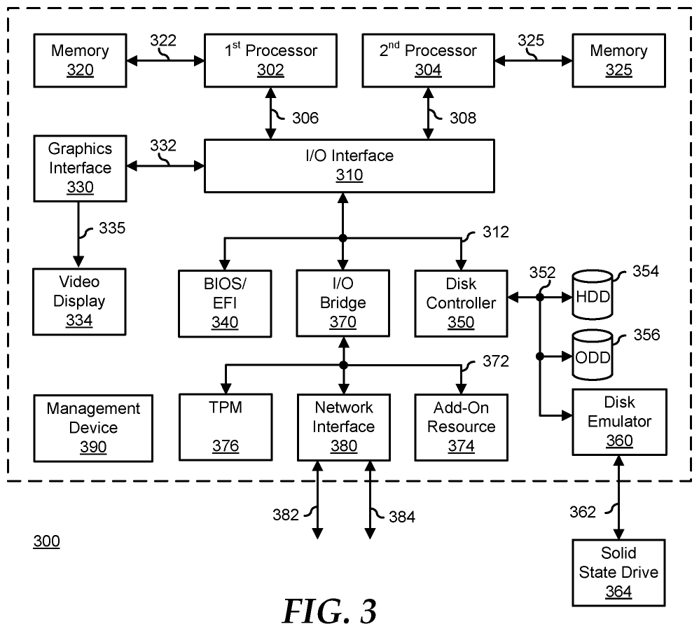

FIG. 3 illustrates a generalized embodiment of an information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 when peripheral interface 372 and the I/O channel are of the same type, and the I/O bridge translates information from a format suitable to the I/O channel to a format suitable to the peripheral channel 372 when they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I²C) interface, a PCIe interface, or the like, to provide an out-of-band (00B) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 when the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An inventory management system, comprising:
a first device having a first inventory identifier uniquely identifying the first device, wherein the first device includes a second device having a second inventory identifier stored in a non-volatile memory of the second device, the second inventory identifier uniquely identifying the second device;
a processing device configured to execute machine-executable code to read the second inventory identifier; and
an inventory log configured to receive the second inventory identifier from the processing device, and to associate the first device with the second inventory identifier.

2. The inventory management system of claim 1, further comprising a third device having a third inventory identifier stored in a non-volatile memory of the third device, the third inventory identifier uniquely identifying the third device.

3. The inventory management system of claim 2, wherein the inventory log is further configured to receive the third inventory identifier from the third device.

4. The inventory management system of claim 3, wherein the inventory log is further configured to associate the third device with the third inventory identifier.

5. The inventory management system of claim 1, wherein the first device includes a communication interface to communicate with the processing device.

6. The inventory management system of claim 5, wherein the first device includes a bridge device bridge communication between the communication interface and the second device.

7. The inventory management system of claim 6, wherein the first device is a Peripheral Component Interconnect-Express (PCIe) card.

8. The inventory management system of claim 7, wherein the second device is an Embedded MultiMedia Card (eMMC).

9. The inventory management system of claim 8, wherein the first identifier is a Piece-Part Identification (PPID) and the second identifier is a Card Identification (CID).

10. The inventory management system of claim 8, wherein the bridge device is a PCIe-to-eMMC bridge device.

11. An method, comprising:
providing, on a first device, a first inventory identifier uniquely identifying the first device;
providing, on a second device included in the first device, a second inventory identifier stored in a non-volatile memory of the second device, the second inventory identifier uniquely identifying the second device;
reading the second inventory identifier from the non-volatile memory of the second device;
receiving, by an inventory log, the second inventory identifier; and
associating the first device with the second inventory identifier in the inventory log.

12. The method of claim 11, further comprising providing, on a third device, a third inventory identifier stored in a non-volatile memory of the third device, the third inventory identifier uniquely identifying the third device.

13. The method of claim 12, further comprising receiving the third inventory identifier from the nonvolatile memory of the third device.

14. The method of claim 13, further comprising associating the third device with the third inventory identifier in the inventory log.

15. The method of claim 11, wherein the first device includes a communication interface to communicate with the processing device.

16. The method of claim 15, wherein the first device includes a bridge device bridge communication between the communication interface and the second device.

17. The method of claim 16, wherein the first device is a Peripheral Component Interconnect-Express (PCIe) card.

18. The method of claim 17, wherein the second device is an Embedded MultiMedia Card (eMMC).

19. The method of claim 18, wherein the first identifier is a Piece-Part Identification (PPID) and the second identifier is a Card Identification (CID).

20. An inventory management system, comprising:
a first device having a first Piece Part Identification (PPID) that uniquely identifies the first device, wherein the first device includes an Embedded MultiMedia Card (eMMC) having a Card Identification (CID) stored in a non-volatile memory of the eMMC, the CID uniquely identifying the eMMC;
a second device having a second PPID stored in a non-volatile memory of the second device, the second PPID uniquely identifying the second device;
a processing device configured to execute machine-executable code to read the CID; and
an inventory log configured to receive the CID from the processing device, to associate the first device with the CID, and to associate the second device with the second PPID.
